(19) United States
(12) Patent Application Publication
(10) Pub. No.: US 2026/0084659 A1
(43) Pub. Date: Mar. 26, 2026

(54) VEHICLE WASH FACILITY ADAPTABLE TO UNDERGROUND GARAGE

(71) Applicant: BEIJING MOGUIYU TECH CO., LTD., Beijing (CN)

(72) Inventor: Wenxuan E, Beijing (CN)

(21) Appl. No.: 19/404,161

(22) Filed: Dec. 1, 2025

Related U.S. Application Data
(63) Continuation of application No. PCT/CN2024/095507, filed on May 27, 2024.

(30) Foreign Application Priority Data
May 29, 2023 (CN) 202321323198.8

(51) Int. Cl. B60S 3/04; E04H 6/08; H04N 7/18; B08B 3/02

(52) U.S. Cl. CPC B60S 3/04; E04H 6/08; H04N 7/18; B08B 3/024

(57) ABSTRACT

A vehicle wash facility adaptable to an underground garage is provided. The vehicle wash facility includes a body which is capable of being integrally built in a region formed by a plurality of parking spots arranged in at least a 3 × 2 array in the underground garage, wherein the body is provided with a washing space, an entrance for a vehicle to enter the washing space, and an exit for the vehicle to exit the washing space, the washing space being obliquely arranged with respect to a carriageway at the entrance.

### CROSS-REFERENCE TO RELATED APPLICATIONS

This is a continuation application of International Patent Application No. PCT/CN2024/095507, filed on May 27, 2024, which claims priority to Chinese Patent application No. 202321323198.8, filed on May 29, 2023 and entitled "CAR WASH SUITABLE FOR UNDERGROUND GARAGE". The disclosures of International Patent Application No. PCT/CN2024/095507 and Chinese Patent application No. 202321323198.8 are incorporated by reference herein in their entireties.

### TECHNICAL FIELD

The present disclosure relates to the technical field of vehicle cleaning, and in particular to a vehicle wash facility adaptable to an underground garage.

### BACKGROUND

With the increasing shortage of urban land resources and the influence of pollution and noise which is easily generated in the vehicle wash facility industry itself, at present, the vehicle wash facility tends to be provided in an underground garage of a shopping mall, an office building and a residential building. The traditional vehicle wash facility located in the underground garage is generally built at the corner or next to the wall, and adopts a manual washing method or a semi-manual washing method. With this type of vehicle wash facility, a vehicle generally enters and exits in the same direction. In this case, the vehicle enters the vehicle wash facility normally, while the vehicle needs to be reversed when exiting the vehicle wash facility, or the vehicle needs to be reversed when entering the vehicle wash facility. Obviously, the vehicle wash facility with such a design structure is not conducive to the automatic washing of a machine in an unattended mode and user experience. Especially for a one-way carriageway in the underground garage, it is more difficult to turn the vehicle directly into the vehicle wash facility in a direction of the front of the vehicle. It is a preferred solution in the unattended mode that a plurality of parking spots are used to build a vehicle wash facility provided with a unidirectional entrance and a unidirectional exit. At present, a width and a length of a straight parking spot in the underground garage are usually 2.2-2.5 meters × 5-5.5 meters (i.e. the width is 2.2-2.5 meters and the length is 5-5.5 meters). Further, there are many pillar network structures in the underground garage. According to the bearing strength of the building, the most economical clear distance between the pillars is generally set to about 7.5 meters. In this way, each side of three parking spots adjacent to each other in a width direction is fixedly provided with a pillar, and each side of two parking spots adjacent to each other in a length direction is also provided with a pillar. As such, 3 × 2 parking spots (totally 6 parking spots arranged in two rows, that is, 6 parking spots arranged in a 3 × 2 array) have become a relatively common design at present. Therefore, for the 3 × 2 parking spots adjacent to each other, a pillar will be provided at each of four corners of the cuboid. Since the length of the parking spot is greater than 7.5 meters, an additional pillar will be provided in the middle of the parking spots in the length direction. Based on the actual height restriction of the underground garage (the general height of the underground garage is about 2.5 meters), the traditional gantry structure mode is usually not applicable in the underground garage. It is a preferred selection to perform a side washing with sliding tracks. However, the length of the cars varies, most of the cars have a length of about 4.6 meters, and the longest vehicle can have a length of 5.5 meters. In order to meet the requirements of versatility, the length of the track should be greater than the maximum length of a normal vehicle, so that the front and rear of the vehicle can be scanned and washed. The experiment proves that the suitable length of the track is about 7.5 meters. Further, an entrance space where the vehicle is located before entering the washing space should have a certain depth to allow the front of the vehicle to turn in. For the carriageway, it has been calculated that if it is desired to directly drive the vehicle from the front of the vehicle into the washing space, it is necessary to preserve at least a certain depth and turning radius. The wider and deeper the entrance space, the more convenient it is for the user to enter. If the user wants to directly enter from the one-way carriageway and park the vehicle straightly, it is calculated that the minimum depth of the entrance is about 3.9 meters, and the minimum width (limited by the maximum turning radius) is about 4.11 meters. Obviously, under the premise of 3 × 2 parking spots, the excessive depth and width of the entrance affects the subsequent layout of the washing machine. For the arrangement of the machine, it is necessary to consider the length of the track. The tracks need to meet the versatility of the length of different cars. For the width between the tracks, it is necessary to consider the eccentricity of the machine. The wider the width between the tracks, the higher the eccentric design requirements, and the more difficult the deployment of the machine. Under the premise of considering the economic cost, combined with the pillar network environment in the underground garage, a technical problem that needs to be solved at present is: how to use the effective parking spot area to design an unattended vehicle wash facility adaptable to the underground garage environment, so that the users can turn into the washing area more conveniently to wash the cars, and the vehicle wash facility has strong versatility to meet the washing of different types of cars.

### SUMMARY

An objective of the present disclosure is to provide a vehicle wash facility which is convenient for the users to enter and exit the washing space and has strong versatility.

According to a first aspect of the present disclosure, a vehicle wash facility adaptable to an underground garage is provided. The vehicle wash facility includes a body which is capable of being integrally built in a region formed by a plurality of parking spots arranged in at least a 3 × 2 array in the underground garage. The body is provided with a washing space, an entrance for a vehicle to enter the washing space, and an exit for the vehicle to exit the washing space. The washing space is obliquely arranged with respect to a carriageway at the entrance.

According to a second aspect of the present disclosure, a vehicle wash facility adaptable to an underground garage is provided. The vehicle wash facility includes a body which is capable of being built in the underground garage. The body includes an entrance barrier, an exit barrier, and partitions for connecting the entrance barrier to the exit barrier. A washing space is defined by the entrance barrier, the exit barrier, and the partitions. An entrance direction of the washing space defined by the entrance barrier is obliquely arranged with respect to a travelling direction of a vehicle along a carriageway at the entrance barrier.

According to a third aspect of the present disclosure, a vehicle wash facility adaptable to an indoor parking garage is provided. The vehicle wash facility includes a body detachably mounted in a plurality of parking spots. The body defines a washing space. The body is provided with an entrance for a vehicle to enter the washing space, and an exit for the vehicle to exit the washing space. The entrance is provided with an entrance door which is openable, and the exit is provided with an exit door which is openable. A center line of the washing space in a width direction of the washing space is at a first acute angle to a travelling direction of the vehicle along a carriageway at the entrance.

### BRIEF DESCRIPTION OF THE DRAWINGS

FIG. 1 is a schematic diagram of parking spots based on which a vehicle wash facility according to this embodiment is built.

FIG. 2 is a schematic top view of a vehicle wash facility adaptable to an underground garage according to this embodiment.

FIG. 3 is a schematic stereoscopic diagram of a vehicle wash facility adaptable to an underground garage according to this embodiment.

FIG. 4 is another schematic diagram of a vehicle wash facility according to this embodiment.

FIG. 5 is another schematic diagram of a vehicle wash facility according to this embodiment.

FIG. 6 (a) is another schematic diagram of a vehicle wash facility according to this embodiment.

FIG. 6 (b) is another schematic diagram of a vehicle wash facility according to this embodiment.

FIG. 7 is another schematic diagram of a vehicle wash facility according to this embodiment.

FIG. 8 is a schematic diagram of an angle of a curved surface of a vehicle wash facility shown in FIG. 7.

FIG. 9 is another schematic diagram of a vehicle wash facility according to an embodiment of the present disclosure.

### DETAILED DESCRIPTION

In order to make the objectives, technical solutions and advantages of the present disclosure more apparent, hereinafter, the present disclosure will be described in detail in connection with the accompanying drawings and embodiments. It should be understood that the specific embodiments described here are merely used to explain the present disclosure, and are not intended to limit the present disclosure.

It should be noted that the drawings provided by this embodiment merely illustrate the basic concept of the present disclosure in a schematic manner.

The structures, proportions, sizes illustrated in the drawings attached to this specification are only used to match the contents disclosed in the specification, so as to be understood and read by those familiar with this technology, and are not used to limit the limiting conditions that the present disclosure can implement. Any modification of structure, change of proportional relationship or adjustment of size, without affecting the efficacy and purpose that the present disclosure can produce, should still fall within the scope of the technical content disclosed by the present disclosure.

In this specification, the terminologies of “front”, “rear”, “left”, “right”, “middle”, “longitudinal”, “transversal”, “horizontal”, “inner”, “outer” and the like that indicate relations of directions or positions are based on the relations of directions or positions shown in the drawings, which are only to facilitate to simplify the description, rather than to indicate or imply that the referred device or element is limited to the specific direction or to be operated or configured in the specific direction. Therefore, the above-mentioned terminologies shall not be interpreted as confine to the present disclosure. In addition, terms “first” and “second” are only adopted for description and should not be understood to indicate or imply relative importance.

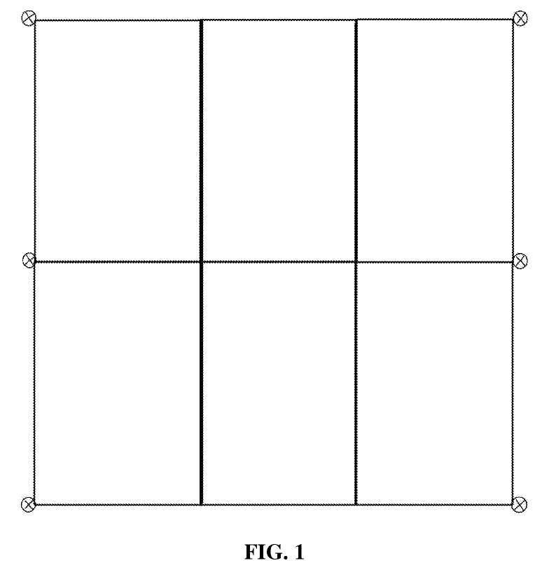

This embodiment provides a vehicle wash facility adaptable to an underground garage. This vehicle wash facility is mainly adaptable to low spaces, such as the underground garage. To build a vehicle wash facility in the underground garage, it is necessary to comprehensively consider various factors, such as the height of the underground garage, the pillar network structure, the size of the parking spot, convenience of entrance and exit of vehicle, water proof and noise proof, washing machine space, equipment storage room space, length, width and height of different cars. As shown in FIG. 1, in the present disclosure, based on the versatility characteristics of the existing standard straight parking spots in the underground garage, six straight parking spots arranged in two rows and adjacent to each other are adopted to build a vehicle wash facility with a cuboid structure in the present disclosure, in which each of the four corners of the cuboid body is located at a respective one of the four pillars of the underground garage. The vehicle wash facility in the present disclosure belongs to a vehicle wash facility for machine intelligent washing in an unattended mode. When the user is driving along the carriageway of the underground garage, the arrow shown in the figure indicates the driving direction of the vehicle, and the user can easily turn the vehicle directly into the entrance space in front of the washing space. After scanning the QR code to pay or verifying the coupons, the entrance barrier at the washing entrance is opened, and the vehicle enters the washing space of the vehicle wash facility, and then the vehicle is stalled and stood still. Image sensors and radar start scanning modeling of vehicle models to generate the vehicle washing paths. Then washing instructions are sent to the washing robot on the tracks, and then the robot completes the automated process of spraying chemicals, rinsing with high pressure water and air drying according to the instructions. Finally, the exit barrier at the exit is automatically opened, and the vehicle exits directly from the other side. The whole washing process is controlled in 6-9 minutes, which greatly reduces the waiting time of the users.

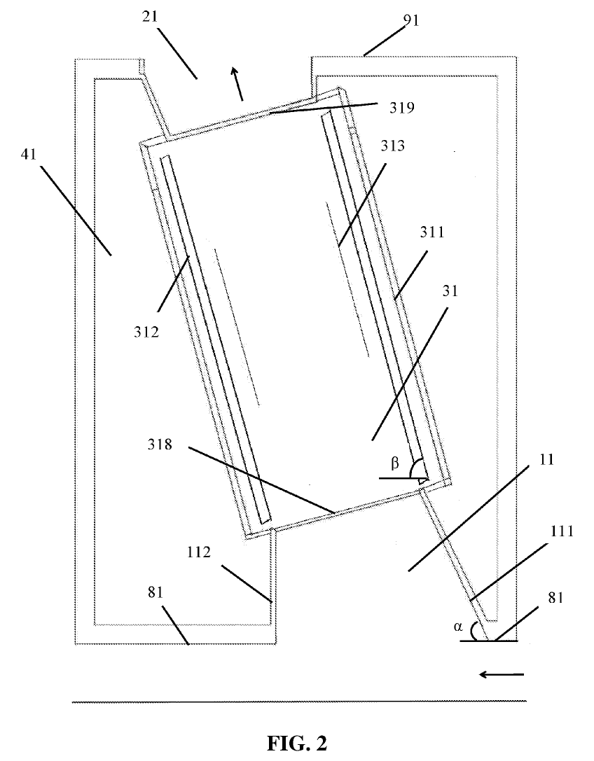

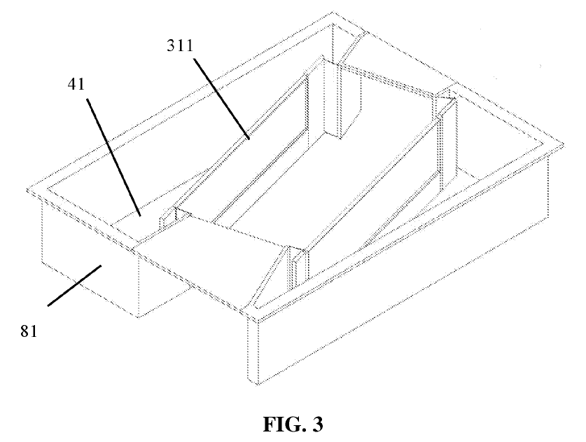

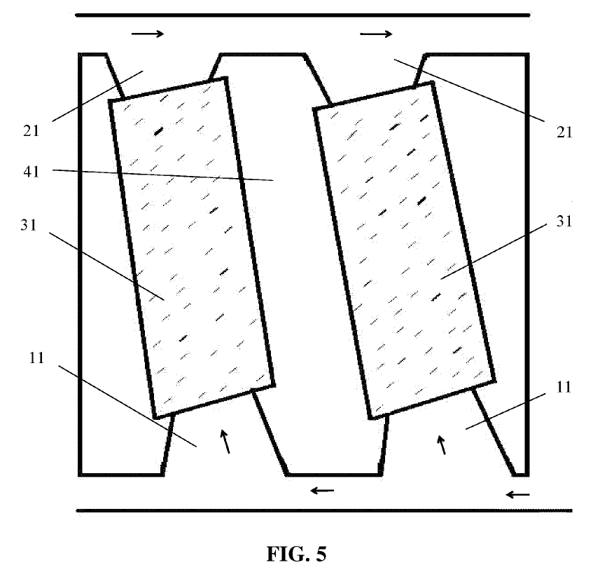

As shown in FIG. 2 and FIG. 3, the vehicle wash facility in this embodiment includes a body with a cuboid structure formed by at least 3 × 2 parking spots adjacent to each other, i.e. parking spots arranged in at least a 3 × 2 array. The body is provided with a front external facade 81, a rear external facade 91, a left external facade and a right external facade, and the outer sides of the body are closed. A carriageway is located outside each of the front external facade 81 and the rear external facade 91. The edges of the body coincide with the outer side of the lines of the parking spot adjacent to each other. The width of the body (in a direction of the carriageway) is a sum of the widths of three parking spots, the length of the body is a sum of the lengths of two parking spots, and the height of the body is determined based on the height of the underground garage. The length, the width and the height of the body can be adjusted according to actual needs. For example, as shown in FIG. 5, when it is desired to build a vehicle wash facility capable of simultaneously washing two cars, two separate washing spaces 31 and two separate entrance passages 11 and two separate exit passages 21 are provided in one integrated vehicle wash facility. In this case, the length and the height of the body remain unchanged, and the width of the body is increased, for example to 10-15 meters, so that the two cars can be simultaneously washed, and the two washing spaces 31 can share the same equipment room in the middle portion. The body in this embodiment includes a washing space 31 located inside, and a top portion of the washing space 31 may be open or closed.

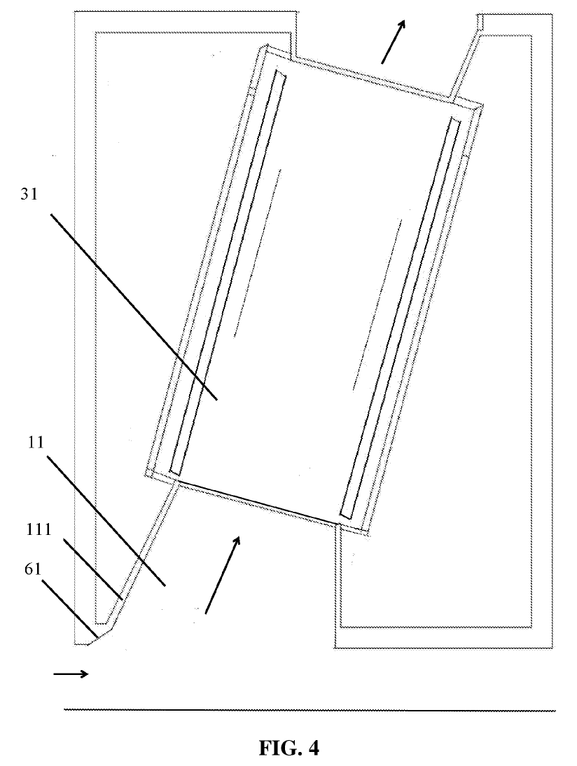

As shown in FIG. 2 and FIG. 3, in this embodiment, a washing space 31 is built in the cuboid body, which is obliquely arranged and is formed by an entrance barrier 318, an exit barrier 319, and two partitions 311 for connecting the entrance barrier 318 to the exit barrier 319. Each of the two partitions 311 is made of a waterproof sealing material or a water absorbent material, and includes one or more of a solid wall, a waterproof wooden board, a waterproof plastic board, a waterproof glass board or combinations thereof, or adopts a water absorbent fabric. Each of the entrance barrier 318 and the exit barrier 319 can be an electric rolling shutter or electric barrier gate controlled by a program. Since a large amount of moisture and noise will be generated in the space during washing, and in order to take into account the safety factors, a sealing structure in the form of an electric door is preferred. Two tracks 312 are fixedly mounted in the body, the two tracks are arranged obliquely and arranged parallel to each other and are configured for moving a washing machine. Herein, an oblique direction is defined relative to two edges of the straight parking spot. Each of the two tracks 312 is located on the ground between the two partitions 311, or is fixed on a respective one of the two partitions 311, or is hoisted on a top portion of the washing space between the two partitions 311. In view of the effect on the eccentricity of the overall structure due to the need for the machine to slide along the tracks and the limitation of the height of the underground garage, it is preferred to arrange the tracks on a platform on the ground, and the vehicle is configured to be parked on the platform between the two tracks 312. An acute angle β formed between each of the two tracks 312 and a carriageway at each of an entrance and an exit of the washing space 31 is from 60 degrees to 90 degrees. If the inclination is too low, the length of the track and the length of the washing space are reduced, thus, a preferred angle is from 70 degrees to 80 degrees. By setting an oblique angle, on the one hand, it is convenient for the vehicle to enter at a small turning angle; on the other hand, it is also possible to accommodate the cars of different lengths or widths to the maximum extent, so that the versatility is strong. The oblique direction is a direction from the corner of the body by which the vehicle first passes when travelling along the carriageway according to the ground indication lines to the opposite corner of the cuboid. As shown in FIG. 2, when the vehicle enters from right to left along the carriageway below, the oblique direction is oriented from the lower right corner to the upper left corner. As shown in FIG. 4, when the vehicle enters from left to right along the carriageway below, the oblique direction is oriented from the lower left corner to the upper right corner. At least one independent equipment room 41 for storage is formed by the two partitions 311, the front external facade 81, the rear external facade 91, the left external facade and the right external facade. The equipment room 41 belongs to the body space outside the washing space 31. The equipment room 41 is mainly configured to place some high-pressure water tanks, chemical dispensing cabinets or other raw materials, which are used for washing the machines and equipment on each side. There may be one or two equipment room(s) 41.

Further, the two partitions 311 are arranged vertically on the ground, arranged obliquely to the parking spot line and arranged parallel to each other, and the entrance barrier 318 and the exit barrier 319 are arranged obliquely and arranged parallel to each other, so as to form an oblique washing space (of which the cross section is a parallelogram) to limit the vehicle in a specific area and in a specific parking direction. Further, the entrance barrier 318 and the exit barrier 319 are arranged perpendicularly to the partition 311, so that the formed cross-section of the washing space is cuboid. Preferably, the washing space 31 is obliquely arranged in a diagonal direction of the cuboid body, which meets the necessary entrance depth and track length and has the maximum use space. It should be noted that the diagonal direction here is an approximate direction. Due to the restrictions of the pillars at the diagonal corners, it is possible to allow the extension line of the track not to intersect the pillar at the corner of cuboid, but leaving a short distance therebetween. The height of the partition 311 is generally equal to the height of each of the left external facade and the right external facade. The design of the partitions 311 is mainly configured to prevent the liquid sprayed by the washing machine on the opposite track 312 from overflowing to the two outer sides, and to achieve the waterproof and soundproof effects. Thus, the partitions 311 are not limited to be linear. For example, the partition 311 is designed to be a deployable and foldable component or in a curved shape with a certain curvature, which can achieve the waterproof and soundproof effects. Since the lengths of the existing cars are different, if the washing space 31 is arranged in the longitudinal direction of the traditional straight parking spots, for some cars with a longer length, such as Lexus LX, Lincoln Navigator, Patrol, etc., it is only possible to reduce the depths of the entrance passage and the exit passage or increase the length of the vehicle wash facility, which will occupy more parking spots or public space and increase the cost. Moreover, the machine needs to slide along the tracks to perform the image collection on the outline of the vehicle, especially the front and rear of the vehicle, and to wash the vehicle, so that the length of the track is generally greater than the length of the vehicle. The length of the track in the present disclosure is from 6.5 meters to 8 meters, preferably from 7 meters to 7.5 meters, which is about 2 meters longer than the longest vehicle (5.5 meters). Therefore, the length of the track itself also limits the length of the entire washing space. The oblique arrangement of the tracks solves this problem. The oblique arrangement of the tracks is not only convenient for users to enter, but also has versatility, which can meet the washing requirements of the cars with different lengths and widths in the market. In addition, the width between the two tracks is designed to be between 2.2 meters and 3.6 meters (based on the external facade), preferably 2.8 meters, which can basically meet the width of general cars in the market. In the present disclosure, by obliquely arranging the washing space 31, the length of the vehicle that can be parked therein is relatively longer in the same usable area, so that the washing space may adapt to more types of cars, and the exit passage and the entrance passage may also be deeper, providing the user’s vehicle a certain turning radius to facilitate for the user to enter and exit and having strong versatility, which is adaptable to large-scale deployment of the vehicle wash facility in the underground garage in an unmanned mode.

The distance between the track 312 and the partition 311 is relatively short, and the washing machine on the tracks 312 is provided with a plurality of free arms facing the vehicle. More preferably, two elongated limit levers 313 are further fixed on the ground between the two tracks 312. The two elongated limit levers 313 are arranged opposite to each other and are configured for defining the parking orientation of the vehicle, and the two elongated limit levers 313 are also arranged parallel to each other. The vehicle needs to be parked between the two elongated limit levers 313. The parallel distance between the two elongated limit levers 313 can at least meet the width of most cars or ordinary SUVs, and the elongated limit levers 313 are spaced apart from the tracks 312 on the left and right sides to leave a contactless washing space for the free arms of the robot and reduce the risk of accidental collision. The elongated limit levers 313, the tracks 312, and the partitions 311 are all arranged obliquely and arranged parallel to each other. The elongated limit levers 313 are provided, so that the user can directly sense them through the rearview mirrors or the tires. Another implementation is to draw limit marking lines on the ground between the two tracks 312 to replace the elongated limit levers. The limit marking lines may be marked by a darkened color such as yellow, red or the like. The limit marking lines can form a parallelogram area or can be set only on the left and right sides.

Further, in the present disclosure, a platform higher than the ground of the underground garage may also be provided on the ground in the washing space 31. The platform is provided with a plurality of through holes. The front end of the platform connected to the exit passage and the rear end of the platform connected to the entrance passage are gentle slopes, and the elongated limit levers 313 and the tracks 312 can be mounted on the platform. The waste liquid generated after washing is buffered and stored on the platform or discharged to the sewer after purification.

As a preferred implementation of the present disclosure, the vehicle wash facility further includes an entrance passage 11 configured for guiding the vehicle into the washing space 31. Since the user needs to scan the QR code to pay or verify the payment before driving the vehicle into the vehicle wash facility, the user needs to hold a mobile phone in the driver’s seat to operate. Since the front of the vehicle has a certain length, in particular for the one-way carriageway, it is more difficult for the user to directly enter the vehicle wash facility. Thus, an entrance passage 11 with a certain depth is specially designed to accommodate at least the front portion of the vehicle. For the one-way carriageway, the depth of the entrance passage 11 needs to be designed to be at least more than 2 meters, so that the vehicle can be turned in for a better user experience, otherwise the vehicle needs to be adjusted multiple times. In order to be compatible with the characteristics of the one-way carriageway and the length of the track, the depth of the entrance passage is preferably designed to be 2-2.6 meters. If a straight parking area is adopted and the user turns the vehicle into the straight parking area and parks the vehicle straightly, the depth of the entrance space and the turning radius of the vehicle will be increased, which is not adaptable to the parking area formed by the pillar network in the garage scene, and also affects the user’s driving experience. A first surface of the entrance passage 11, i.e., the surface of the entrance passage facing the carriageway, is an opening, which is flush with the border line of the carriageway and is relatively wide to facilitate the entry of the vehicle. A second surface of the entrance passage 11 (corresponding to an entrance door of the washing space 31), i.e., the surface of the entrance passage facing the interior of the washing space 31, is relatively narrow, so as to guide the user’s vehicle to the central part of the washing space 31, and facilitate the subsequent machine image scanning and washing processes. The second surface of the entrance passage 11 is provided with an electric door controlled by a program, such as an electric rolling shutter, and the surface of the electric rolling shutter may be covered with an adhesive waterproof film. Specifically, in one embodiment, the entrance passage 11 is provided with two internal facades, i.e., a first internal facade 111 and a second internal facade 112, which are arranged opposite to each other and extend along the first opening toward the interior of the body. The internal facade may be a solid wall or panel. For convenience of explanation, in this embodiment, the internal facade by which the vehicle first passes is defined as the first internal facade 111. The advantage of providing the internal facades is to form a relatively obvious physical guidance angle. Depending on different vehicle travelling directions, when this first internal facade 111 is close to the side on which the main driver scans the QR code, the second internal facade 112 is close to the co-driver. Since the parking spot in the underground garage is usually arranged perpendicular to the carriageway, the user for self-service vehicle wash facility needs to drive the vehicle into the vehicle wash facility in a forward direction (rather than in a reverse direction). However, most of the carriageways in the underground garage are one-way carriageways, and it is basically impossible to turn the vehicle directly into a straight parking spot in the direction of the front of the vehicle once. In order to facilitate the user to turn the vehicle into the vehicle wash facility, in the present disclosure, the angle α between one of the internal facades by which the vehicle first passes when travelling along the carriageway (that is, close to the turning side of the vehicle) and the first opening of the entrance passage 11 (perpendicular to the carriageway on the ground) is set to be less than 90 degrees, preferably from 60 degrees to 80 degrees. In this way, an angle formed between this internal facade and its adjacent front external facade 81 of the body is greater than 90 degrees, but should not exceed 130 degrees, preferably from 100 degrees to 120 degrees, so that the steering wheel turning angle at which the vehicle is turned into the entrance passage 11 from the carriageway close to this internal facade is less than 90 degrees. Combined with the oblique angles of the tracks and the washing space, the turning angle by which the user turns the vehicle from the entrance passage 11 into the washing space 31 is small, which greatly reduces the inconvenience for the user to drive in. An angle formed between the corresponding another internal facade, i.e., the second internal facade 112, and its adjacent external facade of the body may be set from 60 degrees to 120 degrees, that is, this angle may be an acute angle, a right angle, or an obtuse angle.

For example, as shown in FIG. 2, the arrow in the figure indicates the travelling direction of the vehicle. When the vehicle travels from right to left along the carriageway and needs to turn right into the vehicle wash facility, the vehicle first passes by the internal facade on the right side. In this case, the first internal facade 111 on the right side is obliquely arranged, and the angle between the first internal facade and the first opening is an acute angle, and the angle between the first internal facade and its adjacent external facade 81 of the body on the right side is an obtuse angle. The internal facade on the left side is the second internal facade 112, on which an electronic display screen may be provided for prompting relevant information and allowing the user to scan the QR code for payment or verify the QR code. As shown in FIG. 4, when the vehicle travels from left to right along the carriageway and needs to turn left into the vehicle wash facility, the internal facade on the left side is obliquely arranged, and the angle between this internal facade and the front external facade 81 of the body on the left side is greater than or equal to 90 degrees, and the electronic display screen is also provided on the first internal facade 111. One preferred solution is that, the angle between the first internal facade 111 and its adjacent front external facade 81 and the angle between the second internal facade 112 and its adjacent front external facade 81 are both set to be greater than 90 degrees, for example about 100 degrees, as shown in FIG. 5. In this way, regardless of whether the carriageway direction is from left to right or from right to left, the user may easily turn the vehicle into the entrance passage 11.

After washing the vehicle in the washing space, the vehicle needs to exit the washing space. If the exit is flush with the rear external facade 91 of the body, it is not convenient for the user to observe the carriageway environment at the exit in advance. Thus, in the present disclosure, the rear external facade 91 of the body is further provided with an exit passage 21 configured for guiding the vehicle out of the washing space 31. The exit passage 21 also has a certain depth, but is relatively small, so as to facilitate the swing of the rear of the vehicle. The exit passage 21 is also provided with a second opening facing the carriageway and a second surface close to the washing space, and the exit passage 21 is gradually widened from the inner side (the second surface) to the outer side (the first surface) of the body, so that the user can observe the carriageway conditions in the front left and front right of the exit when exiting the vehicle wash facility, the field of view is increased, the turning radius of the vehicle is increased, and it it easier to exit the carriageway turning to the outside. An electric door is also provided at the exit passage 21 close to the washing space 31. When the user’s vehicle starts being washed in the washing space, the electric doors at the entrance and exit are closed under the control of the system to prevent the liquid from flowing out in the washing process. The oblique arrangement direction of the washing space should be substantially consistent with the oblique direction in which the vehicle enters from the entrance passage, so that the steering wheel adjustment range is small when the vehicle enters the washing space. The entrance passage 11 is provided at a corner close to the front external facade 81, the exit passage 21 is provided at a corner close to the rear external facade 91, and the two corners are arranged diagonally in the cuboid, thereby forming the largest operation space.

In this embodiment, the entrance passage 11 is gradually narrowed from the outer side (the first surface) to the inner side (the second surface), and the end opening (i.e., the second surface) of the entrance passage 11 is located between the width defined by the two partitions 311, and the two internal facades of the entrance passage 11 and the respective partitions 311 on the same side may be parallel to each other or form a certain acute angle. As shown in FIG. 2, if the vehicle travels from right to left, it should be turned right into the vehicle wash facility. In this case, the entrance of the entrance passage 11 is biased toward the right corner of the front external facade, and the angle between the first internal facade 111 on the right side and its adjacent partition 311 is between 10 degrees and 25 degrees.

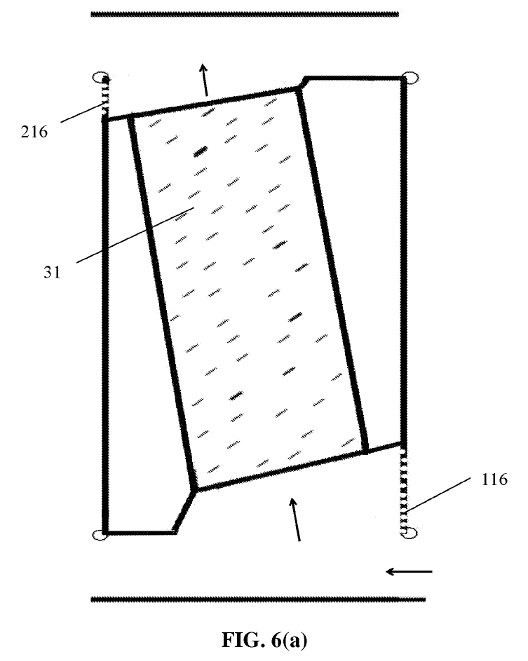

However, it is undeniable that in the embodiment of the present disclosure, the structure of the entrance passage 11 and the exit passage 21 is not limited to the structure shown in FIG. 2. In an example shown in FIG. 6 (a), there is no obvious physical guiding slope of the entrance passage and the exit passage. Compared with the structure shown in FIG. 2, the entrance space for entering the washing space and the exit space for exiting the washing space are made larger, the internal facades for guiding are discarded, and the walls or shelters between the washing entrance and the first opening, such as a portion of the structural surface 116 in the lower right corner of FIG. 6 (a) (the dashed line in the figure is essentially an open surface without a shelter), are removed. Further, a portion of the walls or shelters between the washing exit and the second opening, such as a portion of the structural surface 216 in the upper left corner of FIG. 6 (a) (the dashed line in the figure is essentially an open surface without a shelter), are removed. In this way, a section from the pillar at the corner to the washing opening is completely open. When the user’s vehicle enters, the user can directly see the position of the washing entrance door, thereby facilitating driving the vehicle into the washing space. When the user’s vehicle exits from the washing exit, there is no wall or shelter for blocking, so that the field of view is better during exiting. The above design can also meet the requirements of normal entry, washing and normal exit of the cars. Of course, it is undeniable that in the embodiment of the present disclosure, the entrance passage and the exit passage can also be open, that is, there is no physical guiding surface outside the entrance door and the exit door of the washing space, and the whole entrance passage and the exit passage is made as an open surface, as shown in FIG. 6 (b). Compared with the structure shown in FIG. 6 (a), the entrance passage and the exit passage in FIG. 6 (b) do not actually exist, that is, the two internal facades formed by physical structures do not exist, and the whole entrance passage and the exit passage is open. In this case, the entry direction may be defined by drawing the turning indicator lines or using the plastic road cones in the entrance space.

The design of the internal facades can more intuitively guide the user to start turning the steering wheel from a physical perspective, and can increase the storage volume of the equipment room, so that the overall space utilization is higher. The internal facade by which the vehicle first passes when travelling along the carriageway can be an independent inclined flat surface or an irregular surface composed of several inclined (including vertical) flat surfaces, and the angle between each inclined flat surface and the first opening should be an acute angle. In this way, the angle between the overall inclination of the irregular flat surface and the first opening is an acute angle, which is also convenient for user to turn. For example, as shown in FIG. 4, the vehicle travels from left to right and turns into the vehicle wash facility. In this case, an inclined transition section 61 is added between the original first internal facade where the vehicle turns and its adjacent front external facade 81 of the body, so that one original corner becomes two or more corners. The angle between this transition section 61 and its adjacent internal facade and the angle between this transition section 61 and its adjacent front external facade 81 of the body are both greater than 90 degrees, and the addition of the transition section 61 can further reduce the difficulty for the vehicle to turn in and make the turning smoother.

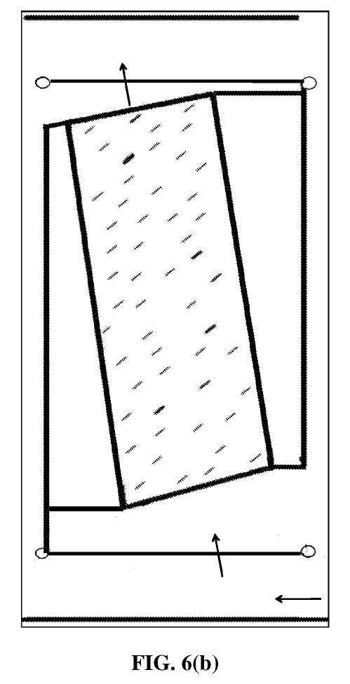

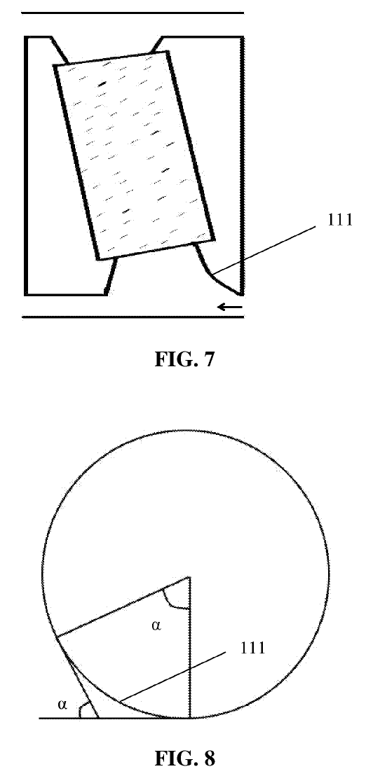

As shown in FIG. 7 and FIG. 8, when the first internal facade is composed of several short and inclined flat surfaces, it can be abstracted into a curved surface. As shown in FIG. 7, the internal facade by which the vehicle first passes when travelling along the carriageway is no longer a flat surface, but a curved surface. As shown in FIG. 8, the arc angle of the curved surface is an acute angle, or the angle between the tangent plane of the curved surface and first opening (equal to the arc angle) is an acute angle. Considering that the entrance passage is generally biased towards the corner of cuboid vehicle wash facility, it is convenient to form an oblique space. Therefore, if the first internal facade is a curved surface, the arc angle can be set from 15 degrees to 35 degrees. Such a structure also allows the vehicle to easily turn in.

Of course, the first internal facade may also adopt a structure in which an inclined flat surface and a curved surface are combined, which will not be described in detail here. In principle, the design of the first internal facade is mainly to facilitate guiding the user’s vehicle into the washing space. Therefore, whether the first internal facade is designed as an inclined flat surface or a curved surface with an acute angle with the first opening, or the first internal facade is directly discarded to form an open space and a prominent route guide is drawn in this space area, this requirement can be met.

Compared with the related art, in a vehicle wash facility adaptable to an underground garage in the embodiments of the present disclosure, based on the characteristics of low underground garage and narrow carriageway, the tracks are arranged obliquely in a diagonal direction of the cuboid, so as to form an oblique washing area space and to provide a sufficient large and sufficient deep entrance space for the vehicle to enter the washing space, so that users can easily turn the vehicle directly into the washing space without reversing or adjusting the vehicle multiple times. Further, the vehicle wash facility has strong versatility to meet different types of cars. The user directly exits from the exit passage after washing, which is quick and convenient. The entire vehicle wash facility has a compact and small structure. The convenience of users is considered, and the spatial layout structure of the vehicle wash facility is fully used, so that the cost is relatively economical, and a better user experience can be achieved.

By adopting the vehicle wash facility adaptable to the underground garage of the present disclosure, the technical effects are achieved as follows.

1. With the vehicle wash facility of the present disclosure, based on the characteristics of the narrow carriageway of the underground garage, the plurality of straight parking spots arranged side-by-side, and the pillar network restrictions, a vehicle wash facility provided with a parking space arranged obliquely is formed in the space defined by the plurality of parking spots. After the user’s vehicle passed from the entrance passage by scanning the QR code to pay, the vehicle can enter the washing space in the vehicle wash facility, and an entire set of washing and drying processes are performed on the vehicle by the robot, and then the vehicle exits from the exit passage. The entire process is simple and has a strong implementation, and the user experience is high.

2. Considering the length of the track of machine for washing the cars, different lengths of different cars, the length of the entrance passage and the exit passage, and the length of the parking spot, in the present disclosure, a plurality of standard straight parking spots adjacent to each other are adopted to build an unattended automatic vehicle wash facility, and the washing space is arranged obliquely, that is, the washing space is arranged diagonally in the body, so that the length of the track is large enough, and the versatility is strong. Thus, the vehicle wash facility can meet the washing requirements of cars with different lengths and widths in the existing market.

3. In the vehicle wash facility of the present disclosure, an angle formed between one of the internal facades of the entrance passage and its adjacent first opening of the body is designed to be less than 90 degrees, so that the steering wheel angle at which the vehicle is turned into the entrance passage from the carriageway arranged adjacent to said internal facade (perpendicular to the direction of the parking spot) is less than 90 degrees. In this way, even when travelling along the one-way carriageway in the underground garage, the user can turn the vehicle into the entrance passage once or conveniently without multiple adjustments, so that the user experience is greatly enhanced.

4. With the oblique design of the entrance passage of the present disclosure, the user can have sufficient large adjustment space after turning the vehicle into the entrance passage, and the entrance passage has a sufficient depth. The entrance passage is gradually narrowed from the outer side to the inner side of the body, which facilitates the formation of an entry line for physically guiding the user, and facilitates guiding the user to park the vehicle in the middle position of the vehicle washing area. The exit passage is gradually widened from the inner side to the outer side of the body, so that the field of view is wide enough when the vehicle exits, which is convenient for the user to observe the road conditions in the forward carriageway, and the rear of the vehicle is not easily collided when the user is turning the vehicle.

5. In the present disclosure, the elongated limit levers or limit areas visible to the naked eye are provided between the two tracks in the washing space, so as to further limit the distance between the vehicle and the washing equipment on the left and right tracks, thereby improving the safety of unmanned washing.

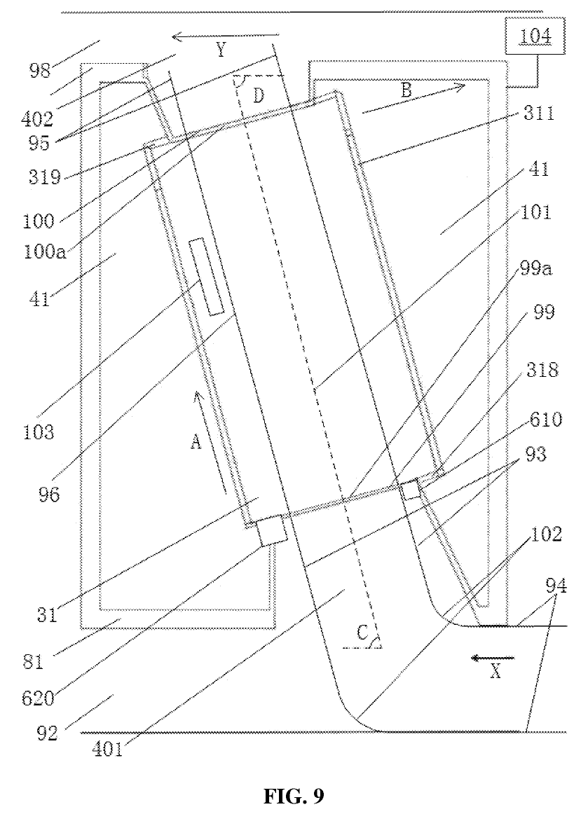

The present disclosure further provides a vehicle wash facility adaptable to an indoor parking garage. As shown in FIG. 9, the vehicle wash facility includes a body detachably mounted in a plurality of parking spots. The body includes an entrance barrier 318, an exit barrier 319, and partitions 311 for connecting the entrance barrier 318 to the exit barrier 319. A washing space 31 is defined by the entrance barrier 318, the exit barrier 319, and the partitions 311. The body is provided with an entrance 99 for a vehicle to enter the washing space 31, and an exit 100 for the vehicle to exit the washing space 31. The entrance 99 is provided with an entrance door 99a which is openable, and the exit 100 is provided with an exit door 100a which is openable.

A center line 101 of the washing space 31 in a width direction B of the washing space 31 is at a first acute angle to a travelling direction X of the vehicle along a carriageway 92 at the entrance 99. By forming an acute angle between the center line 101 and the travelling direction X of the vehicle along the carriageway 92 at the entrance 99, a larger turning radius can be provided for the vehicle desiring to enter the entrance 99, and the vehicle can easily turn into the entrance of the vehicle wash facility.

In an example, the vehicle wash facility further includes a washing machine 103 provided in the washing space 31. Further, the vehicle wash facility further includes a controller 104. The controller 104 is configured to communicate with the washing machine 103 to control movement of the washing machine 103 to wash the vehicle in the washing space 31.

In some embodiments, to reserve a sufficient space for driver to execute turns, a distance is reserved between the entrance 99 and the carriageway 92 at the entrance 99, to form an entry turning area 401 for the vehicle to turn into the entrance 99 from the carriageway 92. In some embodiments, the reserved distance is greater than or equal to 2 meters, for example, 2-3 meters. The entry turning area 401 within this range facilitates the driver in turning into the washing space 31 and ensures that it does not excessively occupy the washing space 31, thereby guaranteeing that the washing space 31 has a sufficient area to accommodate larger vehicles.

Further, referring to FIG. 9, in some embodiments, to guide the driver to adjust the vehicle into a posture suitable for entering the washing space 31, an entry auxiliary marker is provided outside the entrance 99. The entry auxiliary marker may adopt various forms and structures capable of fulfilling a marking function. The entry auxiliary marker may be a physical marker or a virtual image, for example, virtual image projected by a projection device or generated by other virtual image equipment. In the embodiment illustrated in FIG. 9, the entry auxiliary marker is guide lines disposed on the ground, such as a guide line indicated by one or more colors. Alternatively, the entry auxiliary marker may also be implemented by a traffic cone or other physical means.

More specifically, referring to FIG. 9, in some embodiments, the entry auxiliary marker defines an entry guiding passage to prompt the driver to drive the vehicle within the range of the guiding passage. Following the guidance of the entry guiding passage, the driver can accurately navigate the vehicle into the entrance 99 of the washing space 31 from the carriageway 92 along the entry guiding passage. In addition, in other embodiments, the entry auxiliary marker may also define an entry guiding center line to guide the driver in driving the vehicle, where the driver drives the vehicle by aligning the middle of the vehicle with the entry guiding center line as much as possible.

Furthermore, in some embodiments, referring to FIG. 9, the entry auxiliary marker may extend from the carriageway 92 via the entry turning area 401 to the entrance 99, to guide the driver to navigate the vehicle into the entrance 99 from the carriageway 92 along the entry auxiliary marker. Meanwhile, in the embodiment illustrated in FIG. 9, the entry auxiliary marker may also be disposed only within the entry turning area 401, and thus the original guide line design of the carriageway 92 does not need to be altered.

Furthermore, in some embodiments, referring to FIG. 9, the entry auxiliary marker includes a first marker segment 93 provided in the entry turning area 401. The first marker segment 93 defines the entry guiding center line or the entry guiding passage, and the first marker segment 93 is at a second acute angle to the travelling direction X of the vehicle along the carriageway 92 at the entrance 99. This acute angle is more favorable for the driver to turn the vehicle from the carriageway 92 towards the entrance 99 than the right angle.

Furthermore, in some embodiments, referring to FIG. 9, the second acute angle between the first marker segment 93 and the travelling direction X of the vehicle along the carriageway 92 at the entrance 99 is equal to the first acute angle between the center line 101 of the washing space 31 in the width direction of the washing space 31 and the travelling direction X of the vehicle along the carriageway 92 at the entrance 99. As such, after the vehicle turns in the direction indicated by the first marker segment 93 from the carriageway 92, it only needs to drive straight into the washing space 31, which reduces the difficulty of the vehicle entering the washing space 31.

Furthermore, in some embodiments, referring to FIG. 9, the entry auxiliary marker further includes a second marker segment 94 provided in the carriageway 92 at the entrance, and an arc-shaped turning segment 102 connecting the first marker segment 93 with the second marker segment 94. A turning radius of the turning segment 102 is greater than or equal to 1.5 meters, and/or a central angle of the turning segment 102 is greater than or equal to 15°. According to this arrangement, the driver can start driving the vehicle under the guidance of the second marker segment 94 and the turning segment 102 immediately from the carriageway 92, thereby turning into the entrance 99 of the washing space 31 more easily. Of course, in some embodiments, the second marker segment 94 and the turning segment 102 may also be omitted.

When the driver drives the vehicle into the entry turning area 401, it is necessary to enable the driver to more clearly know the distance between the vehicle and the entrance 99 at this moment, or the posture of the vehicle at this moment, for example, whether the vehicle is straight, or whether the vehicle is in an intermediate position. In some embodiments, as shown in FIG. 9, the vehicle wash facility further includes an image collection component 610 and a display component 602 for a driver. The image collection component 610 is configured to collect an image in the entry turning area 401. Under the control of the controller 104, the image collected by the image collection component 610 is displayed on the display component 620 for the driver to check a position and a posture of the vehicle in the entry turning area 401. For example, when the driver finds from the image that the vehicle is not straight, he can immediately adjust the posture of the vehicle and make real-time adjustments according to the displayed image. For example, when the driver finds from the image that the vehicle is too far or too close to the entrance 99, he can instantly adjust the position of the vehicle to allow the vehicle to be close to or away from the entrance 99.

The image collection component 610 may employ any device capable of collecting image information, which may be, for example, but is not limited to, an imaging component, an ultrasonic imaging component, a millimeter wave imaging component, or the like. The number of the image collection components 610 is not limited, which may be one or more. The installation location of the image collection component 610 is also not limited, and the image collection component may be installed at one or more different locations. In order to more accurately display the situation of the vehicle in the entry turning area 401, in some embodiments, the image collection component 610 is arranged above the entry turning area 401, for example, suspended directly above the entry turning area 401. The image collected by the image collection component 610 includes, but is not limited to, a top view of the entry turning area 401, so as to better display whether the vehicle is straight or to show the distance between the front of the vehicle and the entrance 99. Of course, the image collection component 610 may display the image from other angles, and is not limited to a top view.

The display component 620 may be a display screen (a pure display screen or a touch screen), or a projection device, such as a projector. To facilitate checking by the driver, the display component 620 may be arranged on the outer wall of the body, or in the entry turning area 401, or at other locations at which the driver in the entry turning area 401 can check. When a projection device is used as the display component 620, the body, other existing structures of the vehicle wash facility, or structures of the original parking garage (such as supporting beams and pillars, etc.) can be used as projection surfaces to project images.

Further, similar to the design at the entrance 99, in some embodiments, as shown in FIG. 9, the center line 101 of the washing space 31 in the width direction of the washing space 31 is at an acute angle D to a travelling direction Y of the vehicle along a carriageway 98 at the exit 100. This acute angle D ensures that the washed vehicle obliquely exits the washing space 31 and enters the carriageway 98. When the carriageway 98 at the exit 100 is a unidirectional carriageway, the travelling direction Y is the direction of the unidirectional carriageway. When the carriageway 98 is a bidirectional carriageway, the travelling direction Y along the carriageway 98 at the exit 100 refers to the travelling direction Y of the carriageway close to the exit 100.

In some embodiments, the acute angle D between the center line 101 of the washing space 31 in the width direction of the washing space 31 and the travelling direction Y of the vehicle along the carriageway 98 at the exit 100 can be equal to the first acute angle C between the center line 101 of the washing space 31 in the width direction of the washing space 31 and the travelling direction X of the vehicle along the carriageway 92 at the entrance 99.

Of course, in some other embodiments, the angle D between the center line 101 of the washing space 31 in the width direction of the washing space 31 and the travelling direction Y of the vehicle along the carriageway 98 at the exit 100 can also be an obtuse angle, so that the vehicle can turn into the carriageway more conveniently and maintain the correct travelling direction.

As shown in FIG. 9, in some embodiments, a distance is reserved between the exit 100 and the carriageway 98 at the exit 100 to form an exit turning area 402 for the vehicle to turn from the exit 100 onto the carriageway 98 at the exit 100. This reserved distance can be determined according to the actual situation, and is usually smaller than the reserved distance at the entrance 99, so as to reduce its occupation area in the washing space 31 and ensure the size range of the washing space 31.

As shown in FIG. 9, in some embodiments, an exit auxiliary marker is provided outside the exit 100 to guide a driver to navigate the vehicle onto the carriageway 98 at the exit 100 along the exit auxiliary marker. Similarly to the entry auxiliary marker, the exit auxiliary marker may adopt various forms and structures capable of fulfilling a marking function, which may be a physical marker or a virtual image. For example, the exit auxiliary marker is a virtual image. In the embodiment shown in FIG. 9, the exit auxiliary marker is a guide line provided on the ground, such as a guide line indicated by one or more colors. Of course, the exit auxiliary marker may also be implemented by a traffic cone or other physical means.

More particularly, in FIG. 9, the exit auxiliary marker defines an exit guiding passage. Following the guidance of this exit guiding passage, the driver can accurately navigate the vehicle from the exit 100 of the washing space 31 onto the carriageway 98. Further, in some other embodiments, the exit auxiliary marker may also guide the driver to navigate the vehicle by defining an exit guiding center line.

Further, in some embodiments, the exit auxiliary marker may extend from the exit 100 via the exit turning area 402 to the carriageway 98 at the exit 100, or may be only provided in the exit turning area 402, so that the design of the original guiding line of the carriageway 98 may not be changed. For example, as shown in FIG. 9, the exit auxiliary marker includes a third marker segment 95 provided in the exit turning area 402. The third marker segment 95 is at a third acute angle to the travelling direction Y of the vehicle along the carriageway 98 at the exit 100.

In some embodiments, the third acute angle between the third marker segment 95 and the travelling direction Y of the vehicle along the carriageway 98 at the exit 100 is equal to the first acute angle between the center line 101 of the washing space 31 in the width direction of the washing space and the travelling direction X of the vehicle along the carriageway 92 at the entrance 99.

In some embodiments, referring to FIG. 9, a fourth marker segment 96 is provided in the washing space 31 and extending through the washing space 31 along a length direction of the washing space 31. The fourth marker segment 96 connects the third marker segment 95 with the first marker segment 93. An oblique angle of the first marker segment 93 with respect to the travelling direction X of the vehicle along the carriageway 92 at the entrance 99, an oblique angle of the third marker segment 95 with respect to the travelling direction X of the vehicle along the carriageway 92 at the entrance 99, and an oblique angle of the fourth marker segment 96 with respect to the travelling direction X of the vehicle along the carriageway 92 at the entrance 99 are equal to each other. Through the fourth marker segment 96, the first marker segment 93 on the outer side of the entrance 99 and the third marker segment 95 on the outer side of the exit 100 can be connected to each other, thereby enabling the driver to have guidance and driving assistance of the entry auxiliary marker throughout the entire process of entering the washing space 31, washing the vehicle, and exiting the washing space 31.

Although the foregoing describes a vehicle wash facility disposed in an indoor parking lot, the vehicle wash facility of the present application may be applied to various parking lots, including but not limited to indoor parking lots and outdoor parking lots. The indoor parking lot may be either an underground or above-ground parking lot located in buildings such as shopping malls, office buildings, and residential buildings, or a multi-level parking garage or dedicated parking floor constructed specifically for parking purposes. Unlike the indoor parking lot, the outdoor parking lot is generally an open-air space, and the vehicle wash facility may also be installed in such an open-air space.

The technical features of the embodiments described above can be arbitrarily combined. In order to make the description simple, not all the possible combinations of the technical features in the above embodiments are completely described. However, all of the combinations of these technical features should be considered as within the scope described in this specification as long as there is no contradiction in the combinations of these technical features.

The above embodiments merely illustrate several implementations of the present disclosure, and the description thereof is specific and detailed, but they are not constructed as limiting the patent scope of the present disclosure. It should be noted that a number of variations and improvements made by those of ordinary skill in the art without departing from the conception of the present disclosure are within the protection scope of the present disclosure. Therefore, the patent protection scope of the present disclosure should be subject to the appended claims.

1. A vehicle wash facility adaptable to an underground garage, comprising a body which is capable of being integrally built in a region formed by a plurality of parking spots arranged in at least a 3 × 2 array in the underground garage, wherein the body is provided with a washing space, an entrance for a vehicle to enter the washing space, and an exit for the vehicle to exit the washing space, the washing space being obliquely arranged with respect to a carriageway at the entrance.

2. The vehicle wash facility according to claim 1, wherein the washing space is defined by an entrance barrier, an exit barrier, and partitions for connecting the entrance barrier to the exit barrier, an acute angle formed between each of the partitions and the carriageway being from 60 degrees to 90 degrees.

3. The vehicle wash facility according to claim 2, wherein the body comprises a front external facade, a rear external facade, a left external facade and a right external facade, wherein at least one equipment room is defined by the partitions, the front external facade, the rear external facade, the left external facade and the right external facade.

4. The vehicle wash facility according to claim 1, wherein the body further comprises at least one equipment room which is located at one side or both sides of the washing space.

5. The vehicle wash facility according to claim 1, wherein the body further comprises an entrance passage configured for guiding the vehicle into the washing space, a steering wheel angle at which the vehicle is turned into the entrance passage from the carriageway is less than 90 degrees.

6. The vehicle wash facility according to claim 5, wherein an oblique direction of the washing space is consistent with an oblique direction in which the vehicle enters from the entrance passage.

7. The vehicle wash facility according to claim 1, further comprising an entrance passage configured for guiding the vehicle into the washing space, wherein the entrance passage is an open space or is formed by solid physical surfaces.

8. The vehicle wash facility according to claim 7, wherein a depth of the entrance passage is from 2 meters to 3 meters, and the entrance passage is provided with two solid internal facades extending toward an entrance door,
wherein one of the two internal facades by which the vehicle first passes when travelling along the carriageway of the underground garage is an inclined flat surface, and an angle formed between the inclined flat surface and a first opening of the body being less than 90 degrees; or
wherein one of the two internal facades by which the vehicle first passes when travelling along the carriageway of the underground garage is a curved surface, if said one of the two internal facades is a curved surface, an angle formed between a tangent plane of the curved surface and a first opening of the body being less than 90 degrees.

9. The vehicle wash facility according to claim 7, wherein the entrance passage is provided with a first opening facing the carriageway of the underground garage, the entrance passage being gradually narrowed from the first opening of the body to an entrance door.

10. A vehicle wash facility adaptable to an underground garage, comprising a body which is capable of being built in the underground garage, wherein the body comprises an entrance barrier, an exit barrier, and partitions for connecting the entrance barrier to the exit barrier, a washing space being defined by the entrance barrier, the exit barrier, and the partitions, an entrance direction of the washing space defined by the entrance barrier is obliquely arranged with respect to a travelling direction of a vehicle along a carriageway at the entrance barrier.

11. The vehicle wash facility according to claim 10, wherein an exit direction of the washing space defined by the exit barrier is obliquely arranged with respect to a travelling direction of the vehicle along a carriageway at the exit barrier.

12. A vehicle wash facility adaptable to an indoor parking garage, comprising a body detachably mounted in a plurality of parking spots, wherein the body defines a washing space, the body being provided with an entrance for a vehicle to enter the washing space, and an exit for the vehicle to exit the washing space, the entrance being provided with an entrance door which is openable, and the exit being provided with an exit door which is openable;
wherein a center line of the washing space in a width direction of the washing space is at a first acute angle to a travelling direction of the vehicle along a carriageway at the entrance.

13. The vehicle wash facility according to claim 12, further comprising:
a washing machine provided in the washing space; and
a controller, wherein the controller is configured to communicate with the washing machine to control movement of the washing machine to wash the vehicle in the washing space.

14. The vehicle wash facility according to claim 12, wherein the center line is a line connecting a midpoint of the entrance in the width direction of the washing space and a midpoint of the exit in the width direction of the washing space.

15. The vehicle wash facility according to claim 12, wherein a distance is reserved between the entrance and the carriageway at the entrance to form an entry turning area for the vehicle to turn from the carriageway at the entrance into the entrance.

16. The vehicle wash facility according to claim 15, wherein an entry auxiliary marker is provided outside the entrance, the entry auxiliary line being configured to guide a driver to navigate the vehicle into the entrance along the entry auxiliary marker.

17. The vehicle wash facility according to claim 16, wherein the entry auxiliary marker comprises a first marker segment provided in the entry turning area, the first marker segment defining an entry guiding center line or an entry guiding passage, and the first marker segment being at a second acute angle to the travelling direction of the vehicle along the carriageway at the entrance.

18. The vehicle wash facility according to claim 17, wherein the second acute angle between the first marker segment and the travelling direction of the vehicle along the carriageway at the entrance is equal to the first acute angle between the center line of the washing space in the width direction of the washing space and the travelling direction of the vehicle along the carriageway at the entrance.

19. The vehicle wash facility according to claim 16, wherein the entry auxiliary marker is a physical marker or a virtual image.

20. The vehicle wash facility according to claim 16, further comprising an image collection component and a display component for a driver, wherein the image collection component is configured to collect an image in the entry turning area, and the display component is configured to display the image collected by the image collection component for the driver to check a position and a posture of the vehicle in the entry turning area.
